(19) United States
(12) Patent Application Publication
(10) Pub. No.: US 2007/0261546 A1
(43) Pub. Date: Nov. 15, 2007

(54) Switch mechanism for trigger of pneumatic tools

(75) Inventor: Yi-Kuan Lee, Ta-Li City (TW)

Correspondence Address: CHARLES E. BAXLEY, ESQ., 90 JOHN STREET, THIRD FLOOR, NEW YORK, NY, 10038, US

(73) Assignee: Samson Power Tool Co., Ltd.

(21) Appl. No.: 11/801,659

(22) Filed: May 10, 2007

(30) Foreign Application Priority Data
May 9, 2006 (TW) 095207915

(51) Int. Cl. F15B 13/04

(52) U.S. Cl. 91/418

(57) ABSTRACT

A pneumatic tool includes an annular space defined between an inner periphery of the space and an outer periphery of the cylinder, the annular space communicates with an adjusting hole. The adjusting hole includes a head, a threaded portion, a contact portion, a shoulder and a communication passage. The adjusting member is threadedly connected to the adjusting hole so that the seal ring is moved with the movement of the adjusting member. A section between the seal ring to the head in the adjusting hole defines an inlet of an escape passage. The seal ring is moved with the adjusting member between two sides of the communication passage so as to control communication between the recess and the escape passage to decide the feature of individual shooting, continuous shooting or high speed shooting.

### FIELD OF THE INVENTION

The present invention relates to a switch mechanism for switching the valve of the trigger unit between continuous shooting and individual shooting.

### BACKGROUND OF THE INVENTION

A conventional pneumatic tool such as a pneumatic nailer generally includes a switch mechanism in the trigger unit which includes a plurality of paths for pressurized air and the switch mechanism includes a movable member to control communication of the paths so as to guide the pressurized air to desired position. A known switch mechanism controls the feature of continuous shooting and individual shooting. When the user switches the switch mechanism to continuous shooting position, the user needs to holds the trigger and push the safety rod against the object each time to eject a nail. In other words, the user has to push the safety rod against the object and remove the nailer away and push the safety rod against the object again to shoot the nail. This takes time to repeatedly move the nailer toward and away from the object.

The present invention intends to provide a switch mechanism for a pneumatic tool and the mechanism enables the pneumatic tool to be switched between individual shooting, continuous shooting and high speed shooting.

### SUMMARY OF THE INVENTION

The pneumatic tool of the present invention includes an annular space defined between an inner periphery of the space and an outer periphery of the cylinder, the annular space communicates with an adjusting hole. The adjusting hole includes a head, a threaded portion, a contact portion, a shoulder and a communication passage. The adjusting member is threadedly connected to the adjusting hole so that the seal ring is moved with the movement of the adjusting member. A section between the seal ring to the head in the adjusting hole defines an inlet of an escape passage. The seal ring is moved with the adjusting member between two sides of the communication passage so as to control communication between the recess and the escape passage to decide the feature of individual shooting, continuous shooting or high speed shooting.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an end cross sectional view of the pneumatic tool of the present invention;

FIG. 2 is a side cross sectional view along line A-A in FIG. 1;

FIG. 3 is a partial and enlarged cross sectional view of FIG. 2;

FIG. 4 is a cross sectional view of FIG. 2 when the trigger is pulled;

FIG. 5 is a cross sectional view to show that the adjusting member is rotated;

FIG. 6 is a cross sectional view along line B-B in FIG. 5;

FIG. 7 is a partial and enlarged cross sectional view of FIG. 5;

FIG. 8 is a cross sectional view to show that the trigger in FIG. 6 is pulled;

FIG. 9 is a cross sectional view to show that the piston is moving backward;

FIG. 10 is a cross sectional view to show that the piston is moved to its original position;

FIG. 11 shows another embodiment of the present invention, and

FIG. 12 shows yet another embodiment of the present invention.

### DETAILED DESCRIPTION OF THE PREFERRED EMBODIMENT

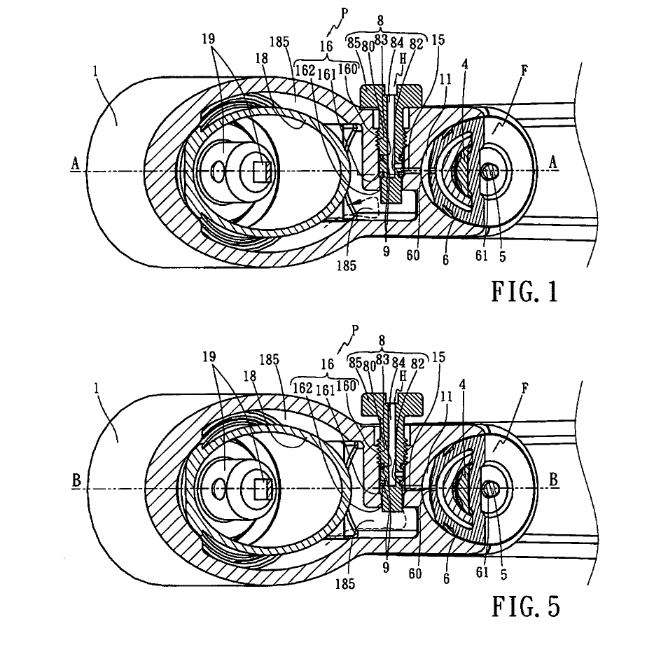

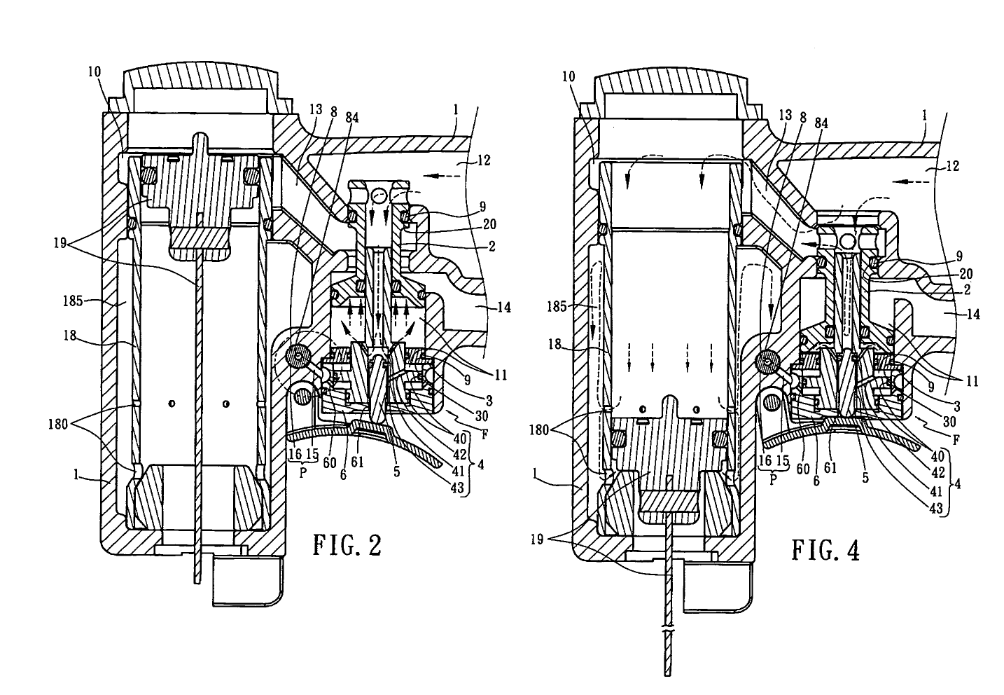

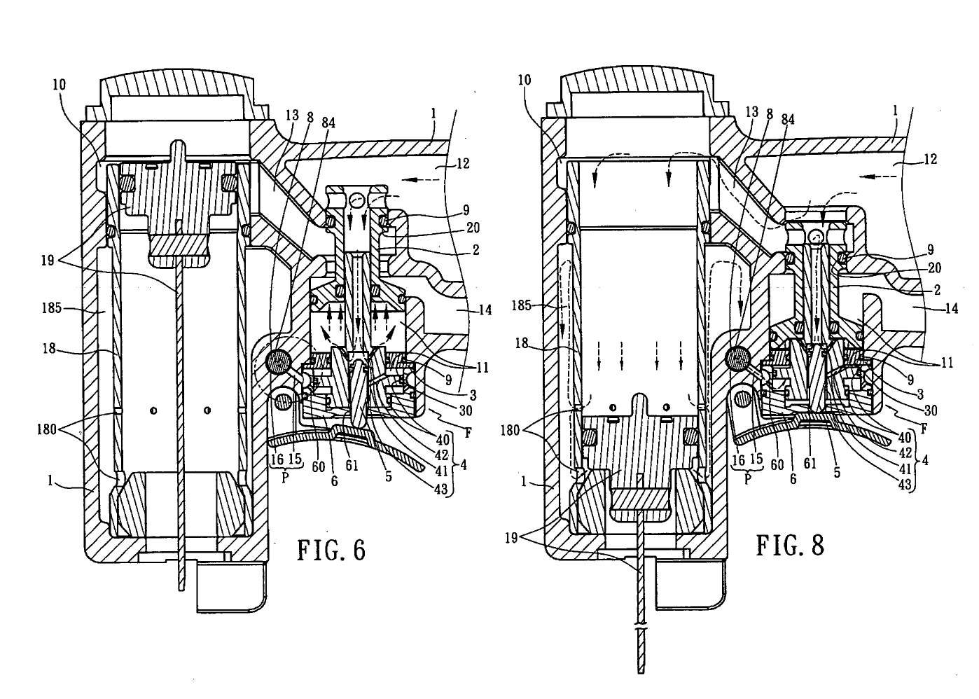

Referring to FIGS. 1 to 10, the pneumatic tool of the present invention comprises a casing including a barrel having a space 10 defined therein, a recess 11 defined in a handle connected to the barrel 1, a main path 12 defined in the handle, a communication path 13, an escape path 14 and a returning path “P”. The cylinder 18 is located in the space 10 and includes a piston 19 which is movably in the cylinder 18. An annular space 185 is defined between the outer periphery of the cylinder 18 and the inner periphery of the space 10 such that when the piston 19 moves toward a front end of the cylinder 18, the air in the cylinder 18 escapes from the side holes 180 and enters into the annular space 185. The space 10 communicates with the recess 11 via the returning path “P” and the communication path 13. The recess 11 communicates with the main path 12, the communication path 13 and the escape path 14. A valve unit “F” is received in the recess 11 and the movable member 2 and the valve 4 of the valve “F” are located in a first partition and the second partition separated by the separation member 3 in the recess 11. The returning path “P” includes a communication passage 15 and an adjusting hole 16, wherein the communication passage 15 is in communication between the adjusting hole 16 and the recess 11. The other end of the adjusting hole 16 communicates with the annular space 185. The adjusting hole 16 includes a threaded portion 160, a contact portion 161, and a shoulder 162. The outer threaded portion 80 of the adjusting member 8 is connected with the threaded portion 160. A seal ring 9 is engaged with a mediate groove 82. A section between the seal ring 9 to he head 85 of the adjusting member 8 and the adjusting hole 16 is arranged such that the inlet of the escape passage “H” is defined. The seal ring 9 is moved with the adjusting member 8 and contacts the contact portion 161 or the left side or the right side of the communication passage 15. By the position of the seal ring 9, the air in the recess 11 can escape from the escape passage “H”. The escape passage “H” can be an L-shaped or inclined hole 84 or slot in the adjusting member 8. The hole 84 is located in a range between the mediate groove 82 to the head 85, or the joint portion of the slot and the adjusting hole 16 is located in a range between the head 85 to the mediate groove 82, or the L-shaped or inclined hole 165 or slot in the casing 1. The adjusting hole 16 has to be located in a range between the head 85 to the mediate groove 82, or the joint portion of the slot and the adjusting hole 16 is located in a range between the head 85 to the mediate groove 82, or the gap defined between the adjusting member 8 and the adjusting hole 16. The gap has one end is located in a range between the mediate groove 82 to the head 85 of the adjusting member 8. The adjusting member 8 includes an outer threaded portion 80, the mediate groove 82 and a rear groove 83, and the seal rings 9 are engaged with the mediate groove 82 and a rear groove 83 respectively. The seal ring 9 in the mediate groove 82 is in contact with the contact portion 161 and located at one side of the communication passage 15 when the adjusting member 8 is connected to the adjusting hole 16. The seal ring 9 in the rear groove 83 is located at the open end of the adjusting hole 16 and located at the other side of the communication passage 15.

The valve unit “F” includes a movable member 2, a separation member 3, a valve 4, a rod 5 and a fixed member 6. The separation member 3 includes an annular groove 30 and a seal ring 9 is engaged with the annular groove 30. The seal ring 9 is located between the recess 11 and the separation member 3, and between the separation member 3 and the valve 4, the movable member 2 and the valve 4 are located in the first and second partitions of the recess 11 respectively.

The movable member 2 includes an annular groove 20 and a seal ring 9 is engaged with the annular groove 20. The movable member 2 and the valve 4 can be mounted with each other and a seal ring 9 is located between the movable member 2 and the valve 4. The movable member 2 is movable in the first partition of the recess 11 so as to decide the air in the main path 12 to flow to the space 10 via the communication path 13, or the air in the space 10 flows to the escape path 14 via the communication path 13.

The valve 4 includes an annular groove 40, a central hole 41, a radial path 42 and a reception path 43, wherein the central hole 41 is in communication between the first partition of the recess 11 and the reception path 43 of the valve 4. The radial path 42 is in communication between the second partition of the recess 11 and the reception path 43 of the valve 4. The seal ring 9 is located in the annular groove 40 and between the valve 4 and the fixed member 6. The rod 5 is movable in the reception path 43 of the valve 4, such that the seal ring 9 on the rod 5 moves over the central hole 41 to decide the air in the main path 12 enters into the first partition of the recess 11 or to allow the air in the first partition of the recess to flow to the reception path 43 and escapes out from the casing 1.

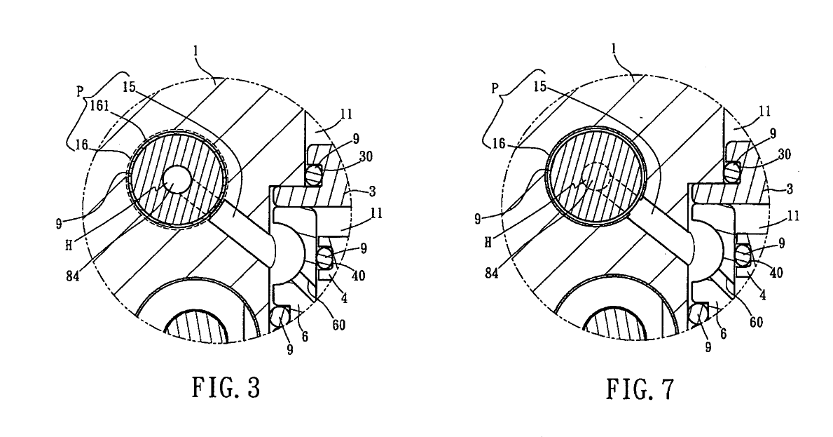

When operating the individual shooting mode, the adjusting member 8 is threadedly rotated to move into the adjusting hole 16 and the seal ring 9 in the mediate groove 82 is in contact with the contact portion 161 of the adjusting hole 16, such that the annular space 185 is not in communication with the returning path “P”. The air in the annular space 185 cannot flow to the returning path “P”. When the seal ring 9 on the rod 5 moves to the central hole 41, the first partition of the recess 11 communicates with the central hole 41, the reception path 43 and the aperture 61. The air in the first partition of the recess 11 escapes via the path mentioned above. Therefore, the air in the main path 12 pushes the movable member 2 to move to the first partition of the recess 11 to stop the communication between the communication path 13 and the escape path 14. The main path 12 communicates with the communication path 13 such that the air pushes the piston 19 to eject a nail and the air in the cylinder 18 flows to the annular space 185 via the side holes 180 as shown in FIG. 3. When the trigger 7 is removed from the rod 5, the seal 9 on the rod 5 is moved over the central hole 41 and the air flows into the first partition of the recess 11 to move the movable member 2 back to its original position. The communication path 13 communicates with the escape path 14, and the air behind the piston 19 escapes from the escape path 14 as shown in FIG. 4.

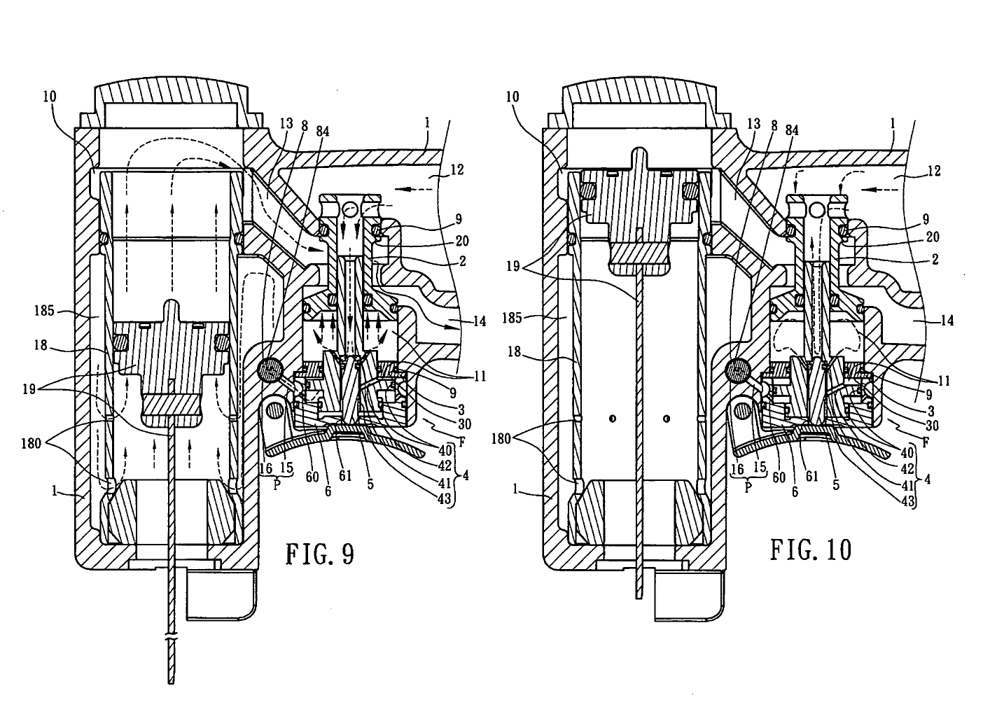

When operating high speed continuous shooting mold, the adjusting member 8 is rotated in reverse direction and the seal ring 9 in the mediate groove 82 seals the adjusting hole 16 and the a gap is defied between the outer periphery of the adjusting member 8 and the contact portion 161 as shown in FIG. 5, so that an open path is formed from the annular groove 185, the returning path “P”, the guide path 60 and the second partition of the recess 11. When the trigger 7 is pulled to move the rod 5, the seal ring 9 on the rod 5 moves beyond the central hole 41 to form an open path from the first partition of the recess 11, the central hole 41, the reception path 43 and the aperture 61. The air pressure in the main path 12 is larger than that in the first partition of the recess 11, so that the movable member 2 is pushed till the seal ring 9 on the movable member 2 seals the neck portion of the space 10. The main path 12 communicates with the communication path 13 which is not in communication with the escape path 14. The air pushes the piston 19 as shown in FIG. 8 and the air in the cylinder 18 flows to the annular space 185 via the side holes 180. The air in the main path 12 can flows to the annular space 185 via the side hole 180 on top of the cylinder 18 and into the second partition of the recess 11 via the guide path 60 and the returning path “P”. The air pressure between the valve 4 and the separation member 3 is smaller than that between the valve 45 and the fixed member 6, so that the space between the valve 4 and the separation member 3 communicates with the reception path 43 via the inclined path 42. The air pressure in the valve 4 and the fixed member 6 pushes the valve 4 till the central hole 41 moves over the seal ring 9 on the rod so that the air in the main path 12 flows into the first partition of the space 11 via the central hole 41. The movable member 2 is pushed till the seal ring 9 on the movable member 2 moves to stop the air in the main path 12 from entering the communication path 13 and the escape path 14 as shown in FIG. 9. The communication path 13 then communicates with the escape path 14 so that the air behind the piston 19 escapes via the communication path 13 and the escape path 14. An open path is formed from the annular space 185, the returning path “P”, the guide path 60 and the second partition (between the valve 4 and the fixed member 6) of the recess 11. The air pressure applied to the top end of the valve 4 is larger than that on the lower end, the valve 4 is moved till the central hole 41 moves over the seal ring 9 on the rod 5 as shown in FIG. 10, and the movable member 2 moves. By repeating motion of the operation mention above, the pneumatic tool is operated continuous shooting or high speed shooting. The size of the gap between the seal ring 9 in the mediate groove 82 and the contact portion 161 of the adjusting member 8 decides the speed of shooting.

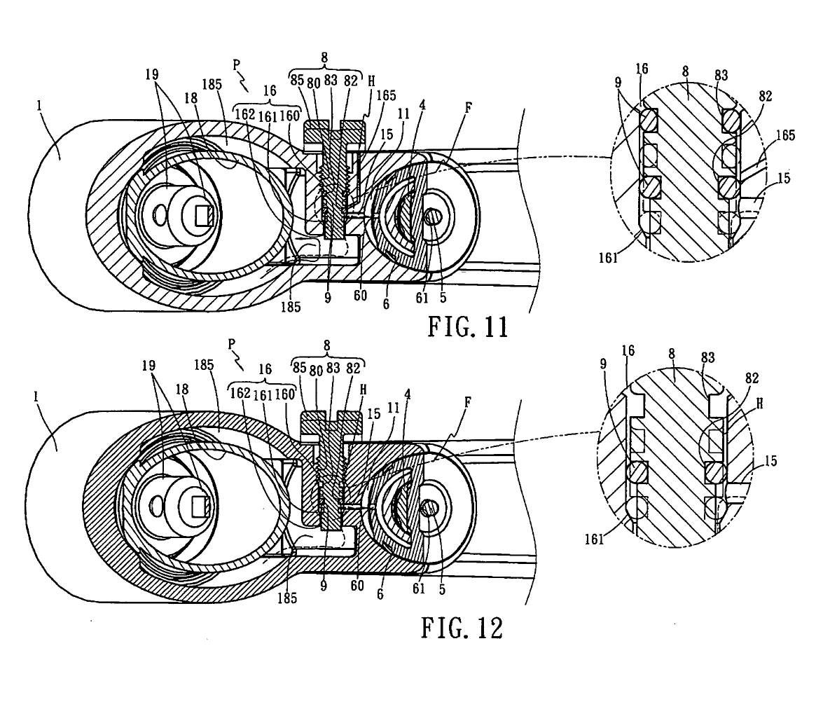

As shown in FIG. 11, another embodiment of the present invention replaces the escape passage “H” formed by the L-shaped hole 84 or slot in the adjusting member 8 with the hole 165 or slot defined in the casing 1. The hole 165 or slot is L-shaped or inclined and is located in a range between the mediate groove 82 and the head 85.

FIG. 12 discloses yet another embodiment of the present invention, wherein the escape passage “H” formed by the L-shaped hole 84 or slot in the adjusting member 8 with the gap, hole or slot defined between the adjusting member 8 and the adjusting hole 16.

While we have shown and described the embodiment in accordance with the present invention, it should be clear to those skilled in the art that further embodiments may be made without departing from the scope of the present invention.

What is claimed is:

1. A pneumatic tool comprising:
a casing and a space defined in a barrel of the casing so as to receive a cylinder therein, an annular space defined between an inner periphery of the space and an outer periphery of the cylinder;
a handle connected to the barrel and including a main path defined therein, a recess defined in the handle and a valve received in the recess, a trigger connected with the valve, an adjusting hole defined in the handle and communicating with the recess via a communication passage, and
an adjusting member having a head and movably and rotatably engaged with the adjusting hole, the adjusting member including a mediate groove and a seal ring engaged with the mediate groove, a section between the seal ring to the head in the adjusting hole defining an inlet of an escape passage, the seal ring moved with the adjusting member between two sides of the communication passage so as to control communication between the recess and the escape passage.

2. The pneumatic tool as claimed in claim 1, wherein the escape passage is a hole defined in the adjusting member.

3. The pneumatic tool as claimed in claim 1, wherein the escape passage is a hole defined in the handle.

4. The pneumatic tool as claimed in claim 1, wherein the escape passage is a gap defined between the adjusting member and the adjusting hole.

5. The pneumatic tool as claimed in claim 2, wherein the adjusting member includes an outer threaded portion which is connected with threaded portion of the adjusting hole.

6. The pneumatic tool as claimed in claim 5, wherein the adjusting member includes a rear groove and a seal ring is engaged with the rear groove, the seal ring is located the other side of the communication passage.
